(19) United States
(12) Patent Application Publication
(10) Pub. No.: US 2026/0094983 A1
(43) Pub. Date: Apr. 2, 2026

(54) TERMINAL BLOCK

(71) Applicant: SUMITOMO WIRING SYSTEMS, LTD., Mie (JP)

(72) Inventor: Koji SAKAKURA, Mie (JP)

(21) Appl. No.: 19/335,651

(22) Filed: Sep. 22, 2025

(30) Foreign Application Priority Data
Sep. 30, 2024 (JP) 2024-170004

(51) Int. Cl. H01R 9/24

(52) U.S. Cl. CPC H01R 9/2416

(57) ABSTRACT

A terminal block includes a nut, a body portion including a nut holding portion for holding the nut, and a busbar for covering the nut from an upper side along a through axis Z of the nut. The nut holding portion includes an opening for enabling the nut to be inserted into the nut holding portion along an insertion direction Y1 along an insertion axis Y orthogonal to the through axis Z. At least one side surface, out of a pair of side surfaces constituting the opening, is a part of an inner surface of a plate-like side wall. The busbar includes an engaging projection to be engaged with the side wall to hinder the side wall from being deformed to open the opening.

### CROSS-REFERENCE TO RELATED APPLICATIONS

This application is based on and claims priority from Japanese Patent Application No. 2024-170004, filed on Sep. 30, 2024, with the Japan Patent Office, the disclosure of which is incorporated herein in its entirety by reference.

### TECHNICAL FIELD

The present invention relates to a terminal block.

### BACKGROUND

Conventionally, a terminal block provided with a nut, a body portion including a nut holding portion for holding the nut and a busbar for covering the nut from an upper side along a through axis of the nut (see, for example, Japanese Patent Laid-open Publication No. 2018-010723). The nut holding portion includes an opening for enabling the nut to be inserted into the nut holding portion along a direction orthogonal to the through axis. A side surface constituting the opening is a part of the inner surface of a plate-like side wall. A pressing rib projecting to hold the nut is provided on the inner surface of the side wall. An accommodation recess for accommodating an upper end part of the nut is provided in the lower surface of the busbar, and an inner diameter of the accommodation recess is designed to be smaller than a distance between a pair of side walls forming the opening (see FIG. 5). In this way, even if the nut corotates with a bolt, the rotation of the nut is prevented by the accommodation recess of the busbar. Thus, an amount to be scraped by the pressing rib can be reduced as compared to the case where the accommodation recess is not provided. Therefore, for example, even if the bolt is repeatedly attached and detached, it can be suppressed that the pressing rib is worn out and a nut holding force is reduced. As a result, the detachment of the nut from the nut holding portion is prevented.

### SUMMARY

In the terminal block as described above, the busbar including the accommodation recess is required to have high-level dimensional accuracy with respect to the nut and the body portion, wherefore there has been a problem in the manufacturability of the busbar.

The present disclosure aims to provide a terminal block capable of improving manufacturability while enabling a reduction of a nut holding force to be suppressed.

The present disclosure is directed to a terminal block with a nut, a body portion including a nut holding portion for holding the nut, and a busbar for covering the nut from an upper side along a through axis of the nut, the nut holding portion including an opening for enabling the nut to be inserted into the nut holding portion along an insertion direction along an insertion axis orthogonal to the through axis, at least one side surface, out of a pair of side surfaces constituting the opening, being a part of an inner surface of a plate-like side wall, and the busbar including an engaging projection to be engaged with the side wall to hinder the side wall from being deformed to open the opening.

According to the terminal block of the present disclosure, manufacturability can be improved while a reduction of a nut holding force can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a terminal block in one embodiment.

FIG. 2 is a partial exploded perspective view of the terminal block in the embodiment.

FIG. 3 is a perspective view of a nut holding portion in the embodiment.

FIG. 4 is a partial plan view of the terminal block in the embodiment.

FIG. 5 is a section along 5-5 of FIG. 4.

FIG. 6 is a partial plan view of a terminal block in a modification.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] The terminal block of the present disclosure is provided with a nut, a body portion including a nut holding portion for holding the nut, and a busbar for covering the nut from an upper side along a through axis of the nut, the nut holding portion including an opening for enabling the nut to be inserted into the nut holding portion along an insertion direction along an insertion axis orthogonal to the through axis, at least one side surface, out of a pair of side surfaces constituting the opening, being a part of an inner surface of a plate-like side wall, and the busbar including an engaging projection to be engaged with the side wall to hinder the side wall from being deformed to open the opening.

According to this configuration, since the nut holding portion includes the opening for enabling the nut to be inserted into the nut holding portion along the insertion direction along the insertion axis orthogonal to the through axis, the nut is inserted into the nut holding portion through the opening. Since at least one side surface, out of the pair of side surfaces constituting the opening, is a part of the inner surface of the plate-like side wall and the busbar includes the engaging projection to be engaged with the side wall to hinder the side wall from being deformed to open the opening, a reduction of a nut holding force is suppressed. Further, since the busbar is not required to have high-level dimensional accuracy, for example, as compared to a configuration in which the busbar includes an accommodation recess for accommodating an upper end part of the nut, the manufacturability of the busbar and, consequently, the manufacturability of the terminal block can be improved.

[2] In [1] described above, the engaging projection may be engaged with the side wall at a position closer to the opening than a center position of the nut along the insertion axis.

According to this configuration, since the engaging projection is engaged with the side wall at the position closer to the opening than the center position of the nut along the insertion axis, the side wall can be hindered from being deformed at a position where the side wall is particularly easily deformed.

[3] In [1] or [2] described above, the nut may be held by being press-fit into the nut holding portion, the side wall may include a pressing rib projecting to hold the nut, and the engaging projection may extend along the through axis to the same position as a position where at least the pressing rib is located.

According to this configuration, since the nut is held by being press-fit into the nut holding portion and the side wall includes the pressing rib projecting to hold the nut, the nut is held in the nut holding portion by being pressed by the pressing rib. Since the engaging projection extends along the through axis to the same position as the position where at least the pressing rib is located, the engaging projection receives a force on an extension of a force received from the nut by the pressing rib, wherefore the deformation of the side wall can be stably hindered.

[4] In any one of [1] to [3] described above, the nut may be held by being press-fit into the nut holding portion, the side wall may include a pressing rib projecting to hold the nut, the engaging projection may extend along the insertion axis, and the nut may be a square nut.

According to this configuration, since the nut is held by being press-fit into the nut holding portion and the side wall includes the pressing rib projecting to hold the nut, the nut is held in the nut holding portion by being pressed by the pressing rib. Since the engaging projection extends along the insertion axis and the nut is a square nut, a contact range with the nut along the insertion axis is increased. Thus, the nut holding portion can stably hold the nut.

[5] In any one of [1] to [4] described above, the body portion and the busbar may constitute an integrally molded product.

According to this configuration, since the body portion and the busbar constitute an integrally molded product, the engaging projection of the busbar can be engaged with the side wall without any gap. Thus, the deformation of the side wall can be more strongly hindered.

### Details of Embodiment of Present Disclosure

A specific example of a terminal block 10 of the present disclosure is described below with reference to the drawings. For the convenience of description, some components may be shown in an exaggerated or simplified manner in each drawing. Further, a dimension ratio of each part may be different in each figure. “Orthogonal” in this specification means not only strictly orthogonal, but also substantially orthogonal within a range in which functions and effects in this embodiment are achieved. “Facing each other” in this specification indicates that surfaces or members are at positions in front of each other, and means not only a case where the surfaces or members are at positions perfectly in front of each other, but also a case where the surfaces or members are at positions partially in front of each other. Further, “facing each other” in this specification means both a case where another member different from two parts is interposed between the two parts and a case where nothing is interposed between the two part. Further, terms such as “first, second and third” in this specification are merely used to distinguish objects and do not rank the objects. Note that the present invention is not limited to these illustrations, but is represented by claims and intended to include all changes in the scope of claims and in the meaning and scope of equivalents.

In each figure, a front-rear axis X, an insertion axis Y and a through axis Z orthogonal to each other are shown. In figures, a forward direction X1, which is one direction along the front-rear axis X, and a rearward direction X2, which is a direction opposite to the forward direction X1, are shown. Further, in figures, an insertion direction Y1, which is one direction along the insertion axis Y, and an opposite insertion direction Y2, which is a direction opposite to the insertion direction Y1, are shown. Further, an upward direction Z1, which is one direction along the through axis Z, and a downward direction Z2, which is a direction opposite to the upward direction Z1, are shown.

### (Configuration of Terminal Block 10)

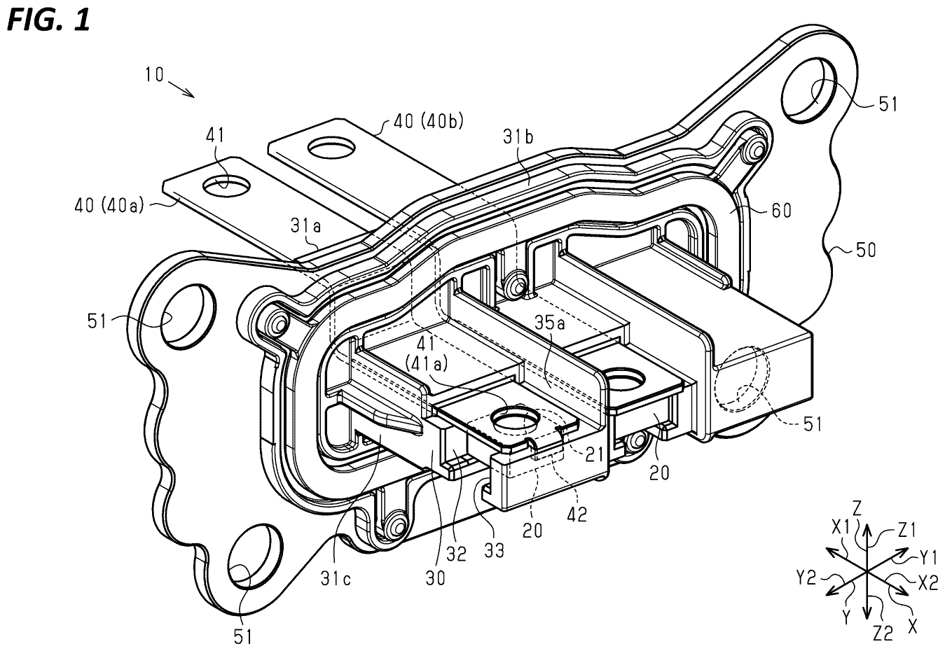

As shown in FIG. 1, the terminal block 10 is provided with nuts 20, a body portion 30, busbars 40, a plate 50 and a packing 60. The terminal block 10 of this embodiment is provided with two nuts 20 and two busbars 40. The two busbars 40 are respectively the busbar 40a and the busbar 40b in this order along the insertion direction Y1, and the respective busbars 40a, 40b have different shapes. Note that, parts relating to the busbar 40a, which are main parts, are described in detail in this embodiment, and the detailed description of parts relating to the busbar 40b is partly omitted.

The terminal block 10 is fixed to an unillustrated attachment target such as a case for accommodating an electrical component, and the plate 50 includes four through holes 51 used for attachment to the attachment object by bolts or the like. The plate 50 is in the form of a rectangular plate along a plane orthogonal to the front-rear axis X, and the through holes 51 are respectively provided on four corners of the plate 50.

### (Configuration of Nut 20)

The nut 20 is made of a metal material.

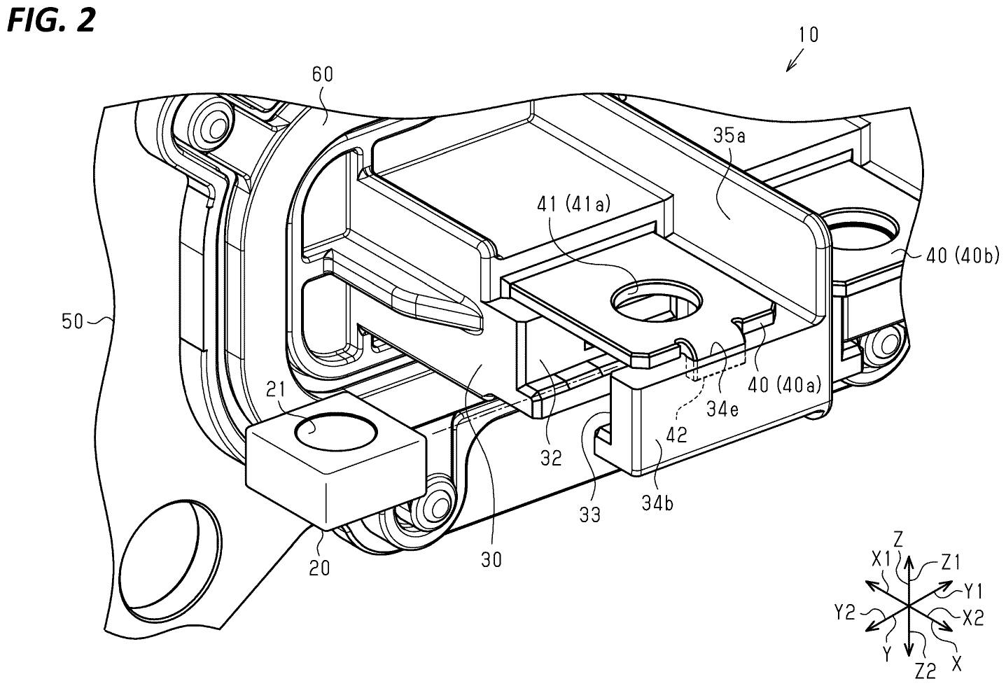

As shown in FIG. 2, the nut 20 is a square nut. That is, the nut 20 has a square outer shape when viewed along the through axis Z. The nut 20 includes an internally threaded hole 21 penetrating along the through axis Z.

### (Configuration of Body Portion 30)

The body portion 30 is made of a resin material.

As shown in FIG. 1, the body portion 30 is molded with the plate 50 sandwiched along the front-rear axis X. In particular, the body portion 30 includes a first body portion 31a for supporting the plate 50 from a front side X1, a second body portion 31b for supporting the plate 50 from a rear side X2 and a third body portion 31c projecting in the rearward direction X2 from the second body portion 31b. The first, second and third body portions 31a, 31b and 31c constitute the same component. The first and second body portions 31a, 31b are integrally formed through an unillustrated through hole provided in the plate 50. The first and second body portions 31a, 31b are in the form of rectangular plates along planes orthogonal to the front-rear axis X. The packing 60 made of a resilient material is provided on a surface on the rear side X2 of the second body portion 31b. The packing 60 is provided along an edge of the second body portion 31b. For example, the packing 60 prevents water or the like from entering the inside of a case for accommodating an electrical component or the like. The third body portion 31c projects in the rearward direction X2 from the inside of the second body portion 31b surrounded by the packing 60. The third body portion 31c has a rectangular parallelepiped shape.

The body portion 30 includes nut holding portions 32 for holding the nuts 20. In particular, the third body portion 31c includes the nut holding portions 32 for holding the nuts 20. The nut holding portion 32 includes an opening 33 for enabling the nut 20 to be inserted into the nut holding portion 32 along the insertion direction Y1 along the insertion axis Y orthogonal to the through axis Z (see FIG. 2). The nut 20 is held by being press-fit into the nut holding portion 32.

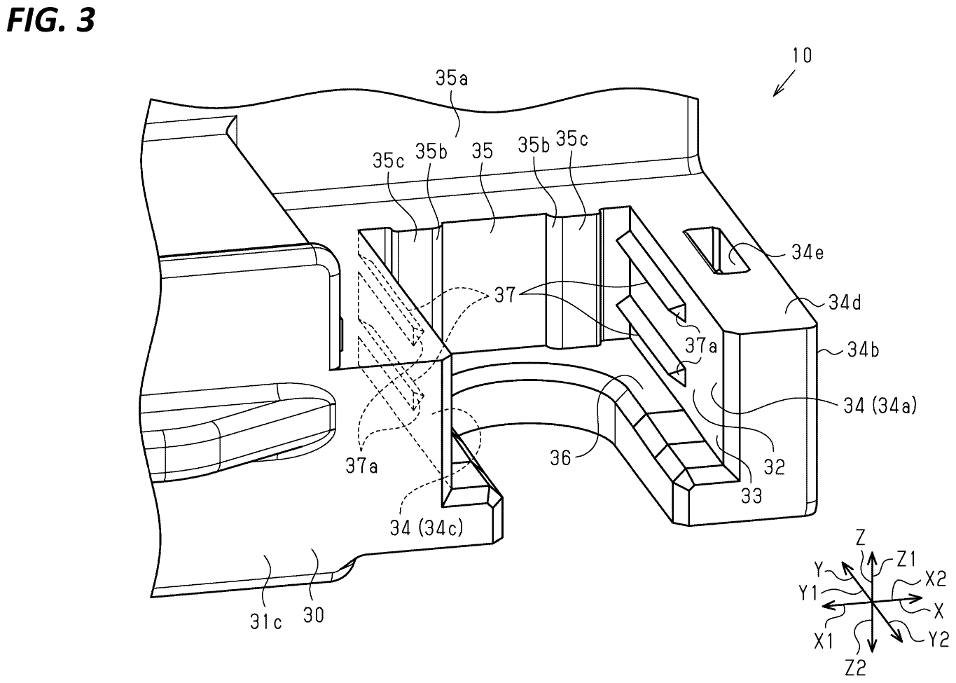

In particular, as shown in FIG. 3, the nut holding portion 32 has a pair of side surfaces 34 and an end surface 35. The pair of side surfaces 34 are continuous with the opening 33 and extend in the insertion direction Y1. In other words, the opening 33 is formed by end parts in the opposite insertion direction Y2 of the pair of side surfaces 34. The end surface 35 connects end parts in the insertion direction Y1 of the pair of side surfaces 34.

Further, the nut holding portion 32 includes a supporting portion 36 capable of supporting the nut 20 from a lower side Z2. The supporting portion 36 is provided on the lower ends of the pair of side surfaces 34 and the end surface 35. The supporting portion 36 projects inwardly of the pair of side surfaces 34 and the end surface 35 and is formed into a U shape.

Out of the pair of side surfaces 34 constituting the opening 33, at least one side surface 34a is a part of the inner surface of a plate-like side wall 34b. The side wall 34b is a wall extending in the opposite insertion direction Y2 from an end part in the rearward direction X2 of the body portion 30.

The side wall 34b includes pressing ribs 37 projecting to hold the nut 20. The pressing ribs 37 project in the forward direction X1 from the side surface 34a of the side wall 34b and extend along the insertion axis Y. The pressing rib 37 is shaped to narrow a width along the through axis Z as projecting in the forward direction X1 from the side surface 34a of the side wall 34b. In this way, the pressing rib 37 is configured such that the tip in the forward direction X1 is more easily plastically deformed. Further, the tip in the opposite insertion direction Y2 of the pressing rib 37 has an inclined portion 37a. In particular, the inclined portion 37a is inclined to reduce a projecting amount in the forward direction X1 from the side surface 34a toward the tip in the opposite insertion direction Y2. In this embodiment, four pressing ribs 37 are provided in the nut holding portion 32. In particular, the side wall 34b includes two pressing ribs 37, and those two pressing ribs 37 are provided at positions separated along the through axis Z. A side surface 34c, which is the side surface 34 constituting the opening 33 and facing the side wall 34b, includes the pressing ribs 37 facing the pressing ribs 37 on the side surface 34a of the side wall 34b. Further, the side wall 34b includes an engaging recess 34e in an upper surface 34d of the side wall 34b.

The end surface 35 constitutes a part of a boundary wall 35a located on a boundary part between the busbars 40a, 40b (see FIG. 2). The end surface 35 includes projecting portions 35b projecting in the opposite insertion direction Y2 and extending along the through axis Z. A projecting surface 35c, which is an end surface in the opposite insertion direction Y2 of the projecting portion 35b, is a flat surface. In this embodiment, the end surface 35 includes two projecting portions 35b.

### (Configuration of Busbars 40)

The busbar 40 is made of a metal material.

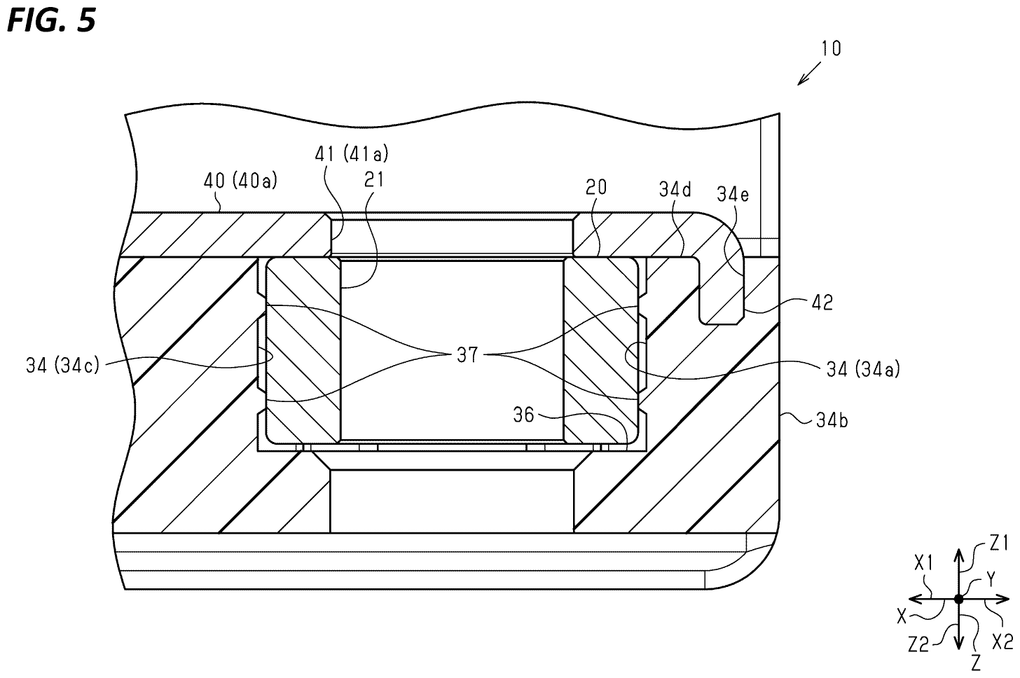

As shown in FIG. 1, the busbar 40 has a plate-like shape extending along the front-rear axis X while having a bending structure in an intermediate part. The busbar 40 covers the nut 20 from the upper side Z1 along the through axis Z of the nut 20. Both end parts of the busbar 40 include through holes 41 penetrating along the through axis Z. In the busbar 40, a diameter of the through hole 41a in a part overlapping the nut 20 is designed to be slightly larger than a diameter of the internally threaded hole 21 (see FIG. 5).

The body portion 30 and the busbars 40 in this embodiment constitute an integrally molded product. In particular, the body portion 30 and the busbars 40 are integrally molded by insert molding. Note that, in this embodiment, the plate 50 is also integrally molded by insert molding in addition to the body portion 30 and the busbars 40.

As shown in FIG. 2, the busbar 40a includes an engaging projection 42. The engaging projection 42 is engaged with the side wall 34b to hinder the side wall 34b from being deformed to open the opening 33. In particular, the engaging projection 42 extends from the tip in the rearward direction X2 of the busbar 40a and is bent in the downward direction Z2. The engaging projection 42 is arranged in the engaging recess 34e of the side wall 34b and engaged with the engaging recess 34e, thereby hindering the side wall 34b from being deformed to open the opening 33 along the front-rear axis X. Note that, in this embodiment, the engaging recess 34e is formed by the engaging projection 42 when the body portion 30 is molded with the busbar 40a as an insert, and the engaging projection 42 is arranged in the engaging recess 34e when the side wall 34b is molded.

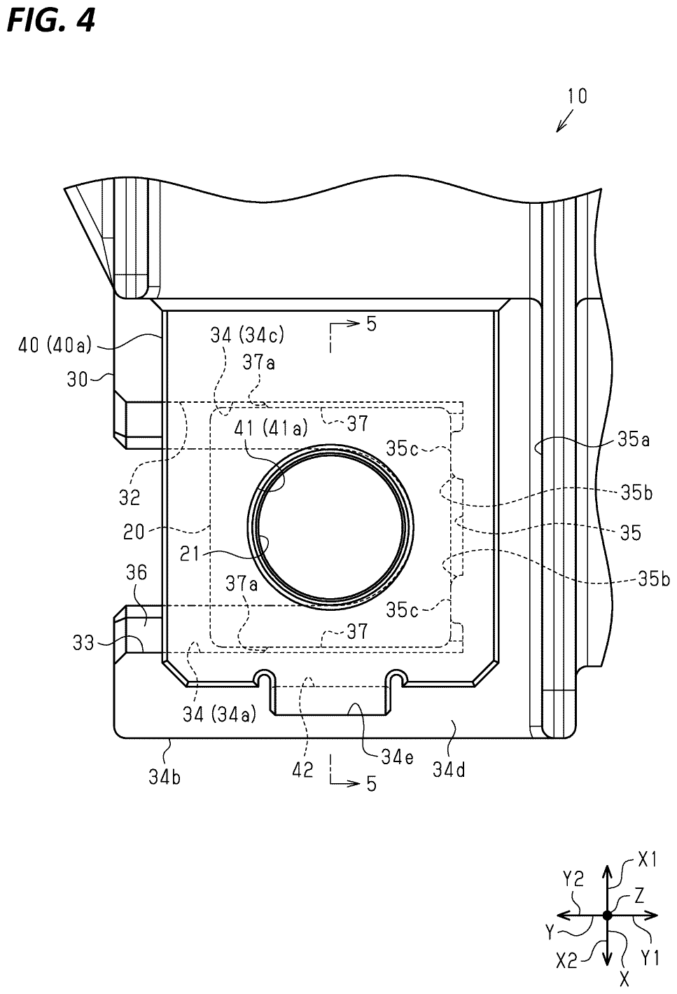

As shown in FIG. 4, the engaging projection 42 is located at a center of the busbar 40a along the insertion axis Y. In particular, a center position of the engaging projection 42 along the insertion axis Y coincides with the position of a center of the through hole 41a and, consequently, coincides with the position of a center of the internally threaded hole 21 of the nut 20. That is, the center position of the engaging projection 42 along the insertion axis Y, the position of the center of the through hole 41a of the busbar 40a and the position of the center of the internally threaded hole 21 of the nut 20 are all located on the same front-rear axis X.

As shown in FIG. 5, the engaging projection 42 extends along the through axis Z to the same position as a position where at least the pressing rib 37 is located. In this embodiment, the engaging projection 42 extends to the pressing rib 37 located further in the upward direction Z1, out of the two pressing ribs 37.

### Functions of Embodiment

Functions of this embodiment are described below.

As shown in FIG. 2, in holding the nut 20 by the nut holding portion 32, the nut 20 is inserted along the insertion direction Y1 through the opening 33 of the nut holding portion 32. The nut 20 is held by being press-fit into the nut holding portion 32.

In particular, as shown in FIG. 4, the nut 20 is inserted into the nut holding portion 32 while being pressed by the tips of the pressing ribs 37, and held in the nut holding portion 32 while being pressed by the tips of the pressing ribs 37. Note that the pressing ribs 37 of this embodiment are so set that the tips thereof are slightly scraped by the nut 20 or slightly squeezed by the nut 20 when the nut 20 is inserted into the nut holding portion 32. A state where the tips of the pressing ribs 37 are scraped is schematically shown in FIG. 5.

As shown in FIG. 4, a state where the nut 20 is in contact with the projecting surfaces 35c of the end surface 35 is a state where the nut 20 is completely inserted in the nut holding portion 32. At this time, the center of the internally threaded hole 21 of the nut 20 and the center of the through hole 41a of the busbar 40a coincide.

In this state, an unillustrated mating terminal is connected to the busbar 40a. Specifically, the busbar 40a and the mating terminal are connected by an unillustrated bolt threadably engaged with the internally threaded hole 21 of the nut 20 through the mating terminal and the busbar 40a with the mating terminal overlaid on the busbar 40 from the upper side Z1.

At this time, if it is assumed that the busbar 40a does not include the engaging projection 42, the nut 20 may corotate due to the application of a rotational force to the nut 20 as the bolt is rotated when being tightened. If corotation occurs, the side wall 34b may be deformed to open the opening 33 as the nut 20 is rotated.

In contrast, the busbar 40a includes the engaging projection 42 and the engaging projection 42 is engaged with the engaging recess 34e of the side wall 34b (see FIG. 5). Thus, even if a rotational force is generated in the nut 20 due to corotation, the side wall 34b is hindered from being deformed to open the opening 33.

### Effects of Embodiment

Next, effects of this embodiment are described below.

(1) Since the nut holding portion 32 includes the opening 33 for enabling the nut 20 to be inserted into the nut holding portion 32 along the insertion direction Y1 along the insertion axis Y orthogonal to the through axis Z, the nut 20 is inserted into the nut holding portion 32 through the opening 33. Out of the pair of side surfaces 34 constituting the opening 33, at least one side surface 34a is a part of the inner surface of the plate-like side wall 34, and the busbar 40a includes the engaging projection 42 to be engaged with the side wall 34b to hinder the side wall 34b from being deformed to open the opening 33. In this way, a reduction of a holding force for holding the nut 20 is suppressed. Specifically, it can be prevented that a force for holding the nut 20 in the nut holding portion 32 is reduced when the bolt is repeatedly attached and detached. Thus, the detachment of the nut 20 from the nut holding portion 32 is prevented. Further, since the busbar 40a is not required to have high-level dimensional accuracy, for example, as compared to a configuration in which the busbar 40 includes an accommodation recess for accommodating an upper end part of the nut 20, the manufacturability of the busbar 40a and, consequently, the manufacturability of the terminal block 10 can be improved.

(2) Sinc the nut 20 is held by being press-fit into the nut holding portion 32 and the side wall 34b includes the pressing ribs 37 projecting to hold the nut 20, the nut 20 is held in the nut holding portion 32 by being pressed by the pressing ribs 37. Since the engaging projection 42 extends along the through axis Z to the same position as the position where at least the pressing rib 37 is located, the engaging projection 42 receives a force on an extension of a force received from the nut 20 by the pressing rib 37, wherefore the deformation of the side wall 34b can be stably hindered.

(3) Since the pressing ribs 37 extend along the insertion axis Y and the nut 20 is a square nut, a contact range with the nut 20 along the insertion axis Y is increased. Thus, the nut holding portion 32 can stably hold the nut 20.

(4) Since the body portion 30 and the busbars 40 in this embodiment constitute an integrally molded product, the engaging projection 42 of the busbar 40 can be engaged with the side wall 34b without any gap. Thus, the deformation of the side wall 34b can be more strongly hindered.

### Modifications

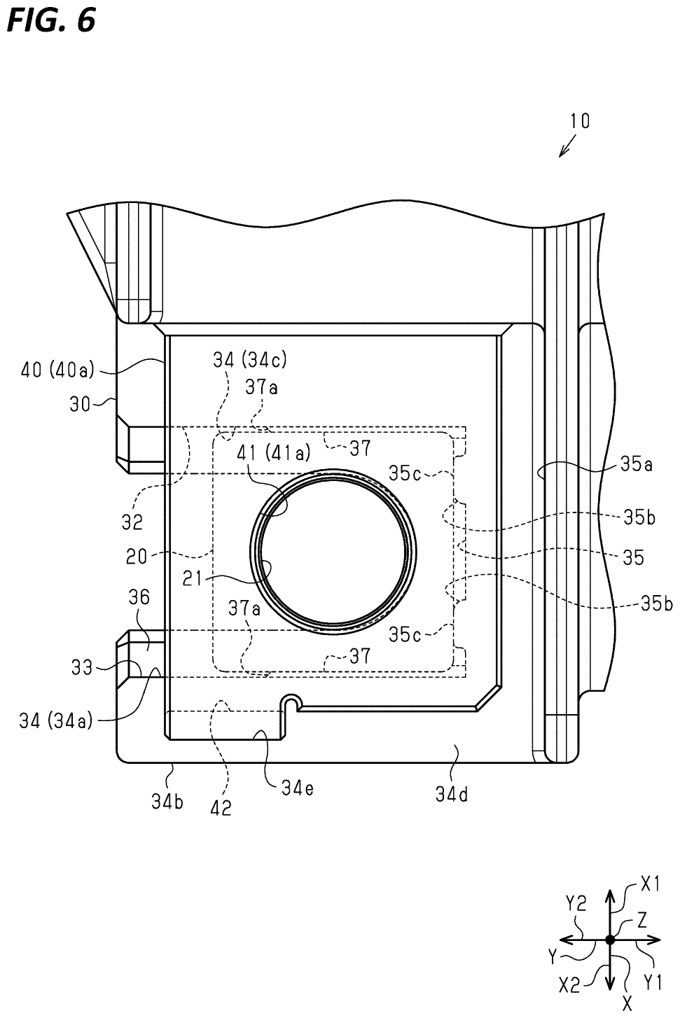

The above embodiment can be modified and carried out as follows. The above embodiment and the following modifications can be combined with each other and carried out without technically contradicting.
As shown in FIG. 6, the engaging projection 42 may be engaged with the side wall 34b at a position closer to the opening 33 than the center position of the nut 20 along the insertion axis Y. In particular, the center position of the engaging projection 42 along the insertion axis Y may be located at a position closer to the opening 33 than the center position of the nut 20. By doing so, the deformation of the side wall 34b can be hindered at a position where the side wall 34b is particularly easily deformed.
Although the engaging projection 42 extends along the through axis Z to the same position as the position where at least the pressing rib 37 is located in the above embodiment, there is no limitation to this and the engaging projection 42 may not extend to the position where the pressing rib 37 is located.
Although the nut 20 is a square nut in the above embodiment, there is no limitation to this and the nut 20 may not be a square nut. That is, the nut 20 may be a polygonal nut such as a hexagonal nut or an octagonal nut.
Although the body portion 30 and the busbars 40 constitute an integrally molded product in the above embodiment, there is no limitation to this and the body portion 30 and the busbars 40 may not constitute an integrally molded product. In this case, the busbars 40 may be, for example, mounted on the body portion 30 from the upper side Z1.
Although the insertion axis Y along the insertion direction Y1 of the nut 20 is orthogonal to the front-rear axis Z, along which the busbars 40 extend, in the above embodiment, there is no limitation to this and the insertion axis Y may coincide with the front-rear axis X.
Although the one side surface 34a, out of the pair of side surfaces 34 constituting the opening 33, is a part of the inner surface of the plate-like side wall 34b in the above embodiment, there is no limitation to this. That is, both of the pair of side surfaces 34 constituting the opening 33 may be respectively parts of the corresponding plate-like side walls. In this case, the busbar 40a may include two engaging projections 42 to be respectively engaged with the both side walls.
Although the side wall 34b includes the engaging recess 34e in the upper surface 34d thereof in the above embodiment, there is no limitation to this and the engaging recess 34e may not be provided. In this case, the engaging projection 42 may be engaged with an outer side surface opposite to the side surface 34 in the side wall 34b.
Although the terminal block 10 is provided with two nuts 20 and two busbars 40 in the above embodiment, there is no limitation to this and the terminal block 10 may be provided one, three or more nuts 20. Further, the terminal block 10 may be provided one, three or more busbars 40.
The embodiment disclosed this time is illustrative in all aspects and the present invention is not limited to these illustrations. That is, the scope of the present invention is represented by claims and intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal block, comprising:
a nut;
a body portion including a nut holding portion for holding the nut; and
a busbar for covering the nut from an upper side along a through axis of the nut,
the nut holding portion including an opening for enabling the nut to be inserted into the nut holding portion along an insertion direction along an insertion axis orthogonal to the through axis,
at least one side surface, out of a pair of side surfaces constituting the opening, being a part of an inner surface of a plate-like side wall, and
the busbar including an engaging projection to be engaged with the side wall to hinder the side wall from being deformed to open the opening.

2. The terminal block of claim 1, wherein the engaging projection is engaged with the side wall at a position closer to the opening than a center position of the nut along the insertion axis.

3. The terminal block of claim 1, wherein:
the nut is held by being press-fit into the nut holding portion,
the side wall includes a pressing rib projecting to hold the nut, and
the engaging projection extends along the through axis to the same position as a position where at least the pressing rib is located.

4. The terminal block of claim 1, wherein:
the nut is held by being press-fit into the nut holding portion,
the side wall includes a pressing rib projecting to hold the nut,
the engaging projection extends along the insertion axis, and
the nut is a square nut.

5. The terminal block of claim 1, wherein the body portion and the busbar constitute an integrally molded product.
